(19) United States
(12) Patent Application Publication
(10) Pub. No.: US 2021/0166181 A1
(43) Pub. Date: Jun. 3, 2021

(54) EQUIPMENT MANAGEMENT METHOD, DEVICE, SYSTEM AND STORAGE MEDIUM

(71) Applicant: Siemens Aktiengesellschaft, Muenchen (DE)

(72) Inventors: Jing WANG, Chengdu (CN); Wen FENG, Chengdu (CN); Shuan Bao LIU, Chengdu (CN); Zhi Quan DENG, Chengdu (CN)

(73) Assignee: Siemens Aktiengesellschaft, Muenchen (DE)

(21) Appl. No.: 17/254,409

(22) PCT Filed: Jun. 27, 2018
(86) PCT No.: PCT/CN2018/093153

§ 371 Date: Dec. 21, 2020

(51) Int. Cl. G06Q 10/06; G06N 3/04; G06N 3/08; G06Q 50/04

(52) U.S. Cl. CPC G06Q 10/06393; G06Q 50/04; G06N 3/084; G06N 3/0454

(57) ABSTRACT

A plurality of component models in a multi-layer composite model are trained using historical production data of a production equipment set. Current production data is input to the composite model; and an adjustment value of a factor is obtained and provided to a piece of equipment. The historical production data includes values of a plurality of factors related to an operating condition within a period of time. An output and input factor of each component model are factors with a parent-child relationship among the plurality of factors. The output factor is a production efficiency index of the production equipment set. In two adjacent layers of the composite model, the output factor of a first layer is the input factor of one or more component models of a second layer. The adjustment value is a value of one or more factors making a predicted value satisfy a condition.

### PRIORITY STATEMENT

This application is the national phase under 35 U.S.C. § 371 of PCT International Application No. PCT/CN2018/093153, which has an International filing date of Jun. 27, 2018, which designated the United States of America, the entire contents of which are hereby incorporated herein by reference.

### FIELD

The present application generally relates to the field of artificial intelligence, in particular to an equipment management method, device, system and a storage medium.

### BACKGROUND

Many companies adopt certain production efficiency indexes (e.g., Overall Equipment Efficiency (OEE), etc.) to monitor the productivity and efficiency of production equipment. The production efficiency index is generally calculated according to a number of input parameters, e.g., operating parameters of production equipment at the production site, configuration data of the production equipment, production plan data, etc. Users can use the production efficiency index to assess the health statuses of production lines and guide the production management. In a conventional method, the production efficiency index is calculated at the end of a production cycle.

Even if there are any potential unreasonable factors that may affect the production process and cause losses, the unreasonable factors can only be detected by calculating the production efficiency index after the production cycle, and it is difficult to determine the parameters causing degradation of the production efficiency index from the numerous input parameters.

### SUMMARY

In view of this, the embodiments of the present application provide an equipment management method, device, system and a storage medium to solve the technical problems that the factors reducing the production efficiency are not discovered in time and are difficult to be positioned.

An embodiment of the present application provides an equipment management method. The method comprises:

acquiring historical production data of a production equipment set, wherein the production equipment set comprises one or more pieces of production equipment, the historical production data comprises a plurality of data sets, and each data set comprises values of a plurality of factors related to an operating condition of the production equipment set within a period of time;

training a plurality of component models in a composite model using the historical production data, wherein an output factor and an input factor of each component model are factors with a preset parent-child relationship among the plurality of factors, wherein the output factor of the composite model is a production efficiency index of the production equipment set, the composite model comprises at least two layers, and in two adjacent layers, the output factor of a component model of a first layer is the input factor of one or more component models of a second layer;

acquiring current production data of the production equipment set, wherein the current production data comprises current values of a first factor, and the first factor is one or more among the plurality of factors;

inputting the current values of the factor to the composite model, and obtaining an adjustment value of a second factor using the composite model, wherein the second factor is one or more among the plurality of factors, and the adjustment value of the second factor is value(s) of one or more factors that makes the predicted value of the production efficiency index satisfy a preset condition; and

providing the adjustment value of the second factor to equipment related to the production equipment set.

It can be seen that a multi-layer composite model is obtained by training with historical production data, so that the composite model can accurately describe the relationship between a large number of factors and a production efficiency index; and using this composite model, the factor that need to be adjusted can be identified from the current production data and a parameter adjustment proposal for optimizing the current production efficiency index can be given, thereby improving the productivity and performance of the production equipment.

An embodiment of the present application also provides an equipment management system, which comprises: data storage equipment and an equipment management device; wherein,

the data storage equipment is configured to:
store historical production data of a production equipment set, wherein the production equipment set comprises one or more pieces of production equipment, the historical production data comprises a plurality of data sets, and each data set comprises values of a plurality of factors related to an operating condition of the production equipment set within a period of time; and
store current production data of the production equipment set, wherein the current production data comprises current values of a first factor, and the first factor is one or more among the plurality of factors;

the equipment management device is configured to:
create a composite model according to a preset parent-child relationship among the plurality of factors, wherein an output factor of the composite model is a production efficiency index of the production equipment set, the composite model comprises at least two layers of component models, in two adjacent layers, the output factor of a component model of a first layer is the input factor of one or more component models of a second layer, and the output factor and input factor of each component model are factors with the preset parent-child relationship among the plurality of factors;
train each component model in the composite model using the historical production data;
input the values of one or more first factors in the current production data to the composite model, and obtain an adjustment value of a second factor using the composite model, wherein the second factor is one or more among the plurality of factors, and the adjustment value of the second factor is value(s) of one or more factors that makes a predicted value of the production efficiency index satisfy a preset condition; and
provide the adjustment value of the one or more second factors to equipment related to the production equipment set.

It can be seen that in the equipment management system of each embodiment, a multi-layer composite model is obtained by training with historical production data, so that the composite model can accurately describe the relationship between a large number of factors and a production efficiency index; and using this composite model, the factor that needs to be adjusted can be identified from the current production data and a parameter adjustment proposal for optimizing the current production efficiency index can be given, thereby improving the productivity and performance of the production equipment.

An embodiment of the present application also provides an equipment management device, comprising:

a model training module, configured to acquire historical production data of a production equipment set, wherein the production equipment set comprises one or more pieces of production equipment, the historical production data comprises a plurality of data sets, and each data set comprises values of a plurality of factors related to an operating condition of the production equipment set within a period of time; and to train a plurality of component models in a composite model using the historical production data, wherein the output factor and input factor of each component model are factors with a preset parent-child relationship among the plurality of factors, wherein the output factor of the composite model is a production efficiency index of the production equipment set, the composite model comprises at least two layers, and in two adjacent layers, the output factor of a component model of a first layer is the input factor of one or more component models of a second layer;

a production adjustment module, configured to acquire current production data of the production equipment set, wherein the current production data comprises current values of a first factor, and the first factor is one or more among the plurality of factors; and to input the current values of the one or more first factors to the composite model, and to obtain an adjustment value of a second factor using the composite model, wherein the second factor is one or more among the plurality of factors, and the adjustment value of the second factors is value(s) of one or more factors that makes a predicted value of the production efficiency index satisfy a preset condition; and

a feedback module, configured to provide the adjustment values of the one or more second factors to terminal equipment related to the production equipment set.

In an embodiment, the present application further provides an equipment management device, comprising: a processor and a memory;

wherein the memory stores an application program executable by the processor to cause the processor to implement the method according to each embodiment of the present application.

It can be seen that the equipment management device of each embodiment can implement the equipment management method of each embodiment, thereby improving the productivity and performance of the production equipment.

An embodiment of the present application also provides a computer readable storage medium, storing computer readable instructions, which can be executed by a processor to implement the method according to each embodiment of the present application.

Thus, according to the computer readable storage medium of each embodiment, the instructions therein enable the processor to implement the equipment management method of each embodiment, thereby improving the productivity and performance of the production equipment.

### BRIEF DESCRIPTION OF THE DRAWINGS

The following will describe preferred embodiments of the present application in detail with reference to the accompanying drawings, so that the above and other features and advantages of the present application are clearer to those of ordinary skill in the art, in which:

FIG. 1A and FIG. 1B are schematic diagrams of an application scenario according to an embodiment of the present application;

FIG. 2 is a schematic diagram of management equipment according to an embodiment of the present application;

FIG. 3 is a flow diagram of an equipment management method according to an embodiment of the present application;

FIG. 4 is a schematic diagram of a composite model according to an embodiment of the present application;

FIG. 5 is a flow diagram of a method for training component models according to an embodiment of the present application;

FIG. 6 is a flow diagram of a method for obtaining a parameter adjustment proposal using a composite model according to an embodiment of the present application;

FIG. 7 is a flow diagram of an equipment management method according to an embodiment of the present application;

FIG. 8 is a schematic diagram of a BP neural network model for implementing a component model according to an embodiment of the present application;

FIG. 9 is a flow diagram of a training method for adding a new factor to a composite model according to an embodiment of the present application;

FIG. 10 is a schematic diagram of dynamic adjustment on production parameters according to an embodiment of the present application.

| No. | Meaning |
|---|---|
| 100, 101 | Application scenario |
| 110 | Management equipment |
| 114 | Database |
| 16, 161, 16N | Production equipment |
| 15, 151, 15N | Acquisition equipment |
| 17, 171, 17N | Configuration equipment |
| 112 | Model training module |
| 116 | Production adjustment module |
| 118 | Feedback module |
| 140 | IoT platform |
| 130 | Network |
| 121, 12N | Factory |
| 206 | Memory |
| 202 | Processor |
| 204 | Network interface |
| 208 | Interconnection mechanism |
| 210 | Operating system |
| 211 | Network communication module |
| 213 | Equipment management module |
| 212 | Model training module |
| 216 | Production adjustment module |
| 218 | Feedback module |
| S31-S35 | Step |
| 400 | Composite model |
| 41, 42, 43, 4n | Layers of composite model |
| 410, 421, 422, 423, 431, | Component model |
| 432, 433, 434, 435, 436 | |
| 40, 4A, 4B, 4C, 4A1, | Factor |
| 4A2, 4An, 4Cl, 4Cn | |
| 500 | Method |
| S51, S52 | Step |
| 600 | Method |
| S61-S64 | Step |
| 700 | Method |
| S71-S75 | Step |
| 900 | Method |
| S91-S95 | Step |

### DETAILED DESCRIPTION OF THE EXAMPLE EMBODIMENTS

In order to make the technical solutions and advantages of the present application clearer, the following further describes the present application in detail in combination with the accompanying drawings and embodiments. It should be understood that the specific embodiments described herein are only used for illustrating the present invention, rather than limiting the protection scope of the present application.

For the sake of simplicity and intuition in the description, the following elaborates the solutions of the present application by describing several representative embodiments. Numerous details in the embodiments are only used for helping understanding the solutions of the present application. However, it is obvious that the technical solutions of the present application may not be limited to these details during implementing. In order to avoid unnecessarily obscuring the solutions of the present application, some embodiments are not described in detail, but only the framework is given. Hereinafter, “comprise” indicates “comprise but not limited to”, and “according to” indicates “at least according to . . . , but not limited to only according to . . . ”. In the description, “first”, “second” . . . are only used for convenient indication, but do not have any substantial meaning. The same kind of object, the first object, the second object, the third object, etc. can be the same object or different objects in each embodiment.

According to each embodiment of the present application, a machine learning model is trained using a machine learning method and historical production data of a production equipment set to obtain a hierarchical model from respective input parameters to intermediate results to a production efficiency index, and the bottleneck that causes a relatively low production efficiency index in the current input parameters can be quickly identified using the hierarchical model, and an adjustment proposal is given, so that the production efficiency of a production equipment set is maintained at a stable and better level.

The equipment management method of each embodiment can be applied to various machine-centric production scenarios (e.g., a production scenario using single production equipment, a single factory using multiple kinds of equipment or production lines, etc.). The equipment management method can be performed by all sorts of equipment (e.g., computing equipment used by a production enterprise, a third-party production management platform, etc.).

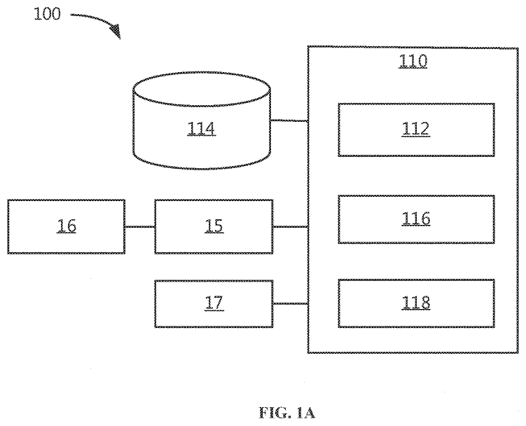

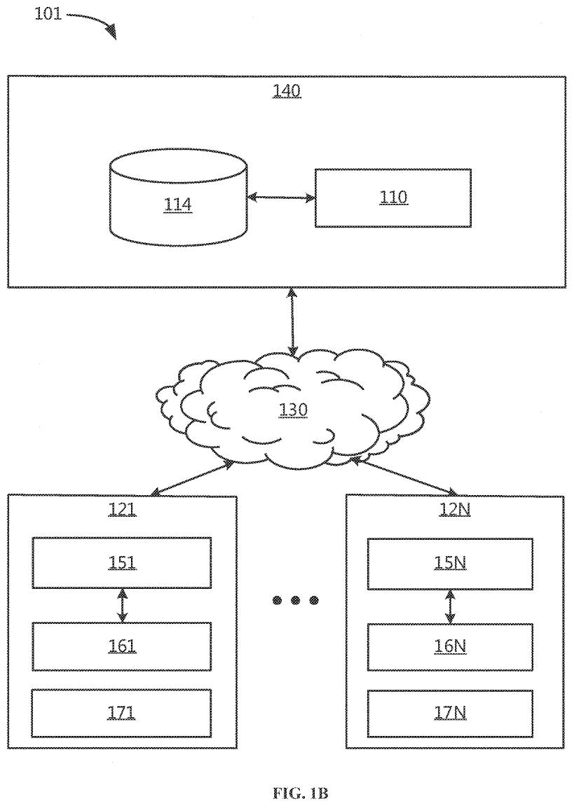

In some embodiments, a production enterprise can manage the production equipment thereof by adopting the method of each embodiment. FIG. 1A is a schematic diagram of an application scenario according to some embodiments of the present application. As shown in FIG. 1A, the application scenario 100 comprises management equipment 110, a database 114, production equipment 16, acquisition equipment 15 and configuration equipment 17. The management equipment 110 can implement an equipment management method of each embodiment.

The production equipment 16 is one or more pieces of equipment that need to be evaluated as a whole for production efficiency, and is also referred to as a production equipment set hereinafter. The production equipment 16 can comprise various kinds of machinery, devices, instruments, facilities and the like required by an enterprise in production for manufacturing or machining. The production equipment 16 can also comprise other auxiliary elements required for production activities using hardware facilities, e.g., software (a control system of the production equipment, etc.), labor (operators, quality inspectors, etc.), elements related to raw material supply, and elements related to product output, etc. The production equipment 16 of different enterprises can have different numbers, types, models, configuration parameters, labor configurations, etc.

The acquisition equipment 15 is the one that can acquire operating data of the production equipment 16. When multiple pieces of production equipment 16 are comprised, the acquisition equipment 15 can be a set of multiple pieces of acquisition equipment. The acquisition equipment 15 can acquire the operating data of the production equipment 16 through one or more pieces of sensing equipment that can automatically acquire production data. The sensing equipment can be the one connected to the production equipment 16 or arranged near the production equipment 16, e.g., various sensors, or a signal receiver (e.g., a radio frequency reader, etc.), or a code reader, etc. For example, the acquisition equipment 15 can acquire the working state of the production equipment 16 through a current sensor, acquire the operating condition of an engine of the production equipment 16 through a revolution speed sensor, acquire the status of the production equipment 16 about raw material input, product output, pipeline operation and the like through a radio frequency reader or a code reader, etc.

The configuration equipment 17 records various configuration parameters related to the production equipment 16 and can also record production status data input manually and related to the production equipment 16. The various parameters recorded in the configuration equipment 17 can comprise, but are not limited to, parameters related to the production equipment 16 (e.g., planned run time, actual run time of the equipment, unexpected failure, failure time, production hours, downtime, speed loss, etc.), parameters related to products (e.g., scraps, quality rate, etc.), labor parameters set for production activities of the production equipment 16 (e.g., labor quantity, labor change, staff turnover, etc.), etc. The configuration equipment 17 can comprise one or more pieces of computing equipment, e.g. equipment for data management, terminal equipment used by a manager, such as a PC, a smart phone, etc.

The database 114 can be independent storage equipment, or storage equipment in the management equipment 110 or the configuration equipment 17. The database 114 can store historical production data of the production equipment 16, i.e., data related to the production status of the production equipment 16 within a certain period in the past. The data can be data coming from the acquisition equipment 15 or the configuration equipment 17, data input manually, or data stored in other data management systems (e.g., an enterprise resource planning system, etc.), etc.

The management equipment 110 can train a composite model corresponding to the production equipment 16 using the historical production data of the production equipment 16, wherein the composite model is used for predicting a certain production efficiency index of the production equipment 16; analyze the current production data of the production equipment 16 using the composite model, and give an adjustment proposal. The adjustment proposal can comprise a proposed value(s) (also referred to as adjustment value) of one or more parameters. The management equipment 110 can be independent equipment, or a component in the configuration equipment 17. The management equipment 110 can communicate with other equipment in various wired or wireless manners. Various wired or wireless manners can comprise a direct connection manner using a cable, a wireless direct connection manner such as Bluetooth or infrared, an indirect connection manner through a local area network, Internet equipment or the like, etc.

As shown in FIG. 1A, the management equipment 110 can comprise a model training module 112, a production adjustment module 116 and a feedback module 118. The model training module 112 can train a plurality of component models in the composite model using the historical production data in the database 114. The production adjustment module 116 can analyze the current production data provided by the acquisition equipment 15 and the configuration equipment 17 using the trained composite model, and give a parameter adjustment proposal. The feedback module 118 can provide the parameter adjustment proposal to the equipment related to the production equipment 16 for adjusting the operating condition of the production equipment 16. The equipment for receiving the parameter adjustment proposal can be equipment arranged at the production site, the configuration equipment 17, or terminal equipment (e.g., a PC, a mobile phone, etc.) used by an enterprise manager, etc. The parameter adjustment proposal can comprise an adjustment proposal for any parameter that affects the production result, e.g., can comprise an adjustment proposal for the operating parameters of the production equipment, can also comprise an adjustment proposal for related facilities and labor, etc.

In some embodiments, the network platform can provide a management service for the production equipment of each production enterprise connected to the platform using the method of each embodiment. FIG. 1B is a schematic diagram of an application scenario according to some other embodiments of the present application. As shown in FIG. 1B, the application scenario 101 comprises an Internet of Things (IoT) platform 140, a network 130 and multiple factories 121-12N. The IoT platform 140 can implement the equipment management method of each embodiment.

The IoT platform 140 is a system that can store and maintain the production data of multiple factories. The IoT platform 140 can communicate with the equipment of multiple enterprises, e.g., the factories 121-12N, via the network 130.

The factories 121-12N comprise respective production equipment 161-16N, acquisition equipment 151-15N and configuration equipment 171-17N. The production equipment 161-16N, the acquisition equipment 151-15N and the configuration equipment 171-117N are similar to the production equipment 16, the acquisition equipment 15 and the configuration equipment 17 shown in FIG. 1A, respectively. The acquisition equipment 151-15N and the configuration equipment 171-17N are all configured to submit data to the IoT platform 140 through the network 130.

The IoT platform 140 can comprise the management equipment 110 and the database 114.

The database 114 can acquire production data, management configurations and the like of the factories 121-12N at different time periods through the network 130. For example, the database 114 can store historical production data of a production equipment set, wherein the production equipment set comprises one or more pieces of production equipment, the historical production data comprises a plurality of data sets, and each data set comprises values of a plurality of factors related to an operating condition of the production equipment set within a period of time; and store current production data of the production equipment set, wherein the current production data comprises a current value of a first factor. The first factor refers to one or more among the above plurality of factors.

The management equipment 110 can create a composite model for each of the factories 121-12N, and provide a parameter adjustment proposal for each of the factories 121-12N. The management equipment 110 can create a composite model according to a preset parent-child relationship among the plurality of factors, and the output factor of the composite model is a production efficiency index of the production equipment set. The composite model is a hierarchical model. The composite model comprises at least two layers of component models, and in two adjacent layers, the output factor of a component model of a first layer is the input factor of one or more component models of a second layer.

The management equipment 110 trains each component model in the composite model using the historical production data.

The management equipment 110 inputs the current values of the first factor in the current production data to the composite model, and obtains an adjustment value of a second factor using the composite model. The second factor is one or more among the above plurality of factors, and the adjustment value of the second factor is value (s) of one or more factors that makes the predicted value of the production efficiency index satisfy a preset condition.

The management equipment 110 provides the adjustment value of the second factor to the equipment related to the production equipment set.

In some embodiments, the IoT platform 140 further comprises data acquisition equipment (not shown). The data acquisition equipment can acquire data related to an operating condition of the production equipment to generate values of a plurality of factors, and store the values of the plurality of factors into the data storage equipment. The data acquisition equipment can acquire the operating data of the production equipment through one or more pieces of first equipment (e.g., acquisition equipment 151-15N, etc.) connected to the production equipment or arranged near the production equipment, or receive configuration data of the production equipment sent by second equipment (e.g., configuration equipment 171-17N, etc.), or read operating data and configuration data of the production equipment from third equipment (e.g., equipment on which a certain data management system runs, etc.).

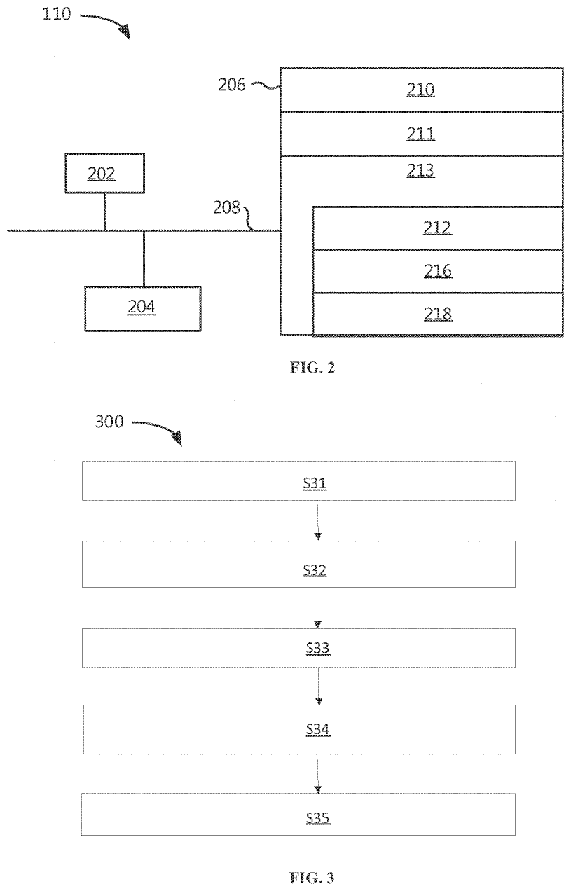

In various embodiments, the management equipment 110 can be implemented by hardware. For example, the model training module 112, the production adjustment module 116 and the feedback module 118 can be hardware modules implemented by a hardware circuit. The management equipment 110 can also be implemented by hardware configured with software. FIG. 2 is a schematic diagram of management equipment according to an embodiment of the present application. As shown in FIG. 2, the management equipment 110 comprises a processor 202, a memory 206 and a network interface 204, and the components can communicate with each other via an interconnection mechanism 208.

The network interface 204 is used for implementing communication between the management equipment 110 and other equipment. The network interface 204 can be communication interface equipment that supports any or more communication protocols.

The processor 202 can comprise one or more single-core or multi-core processors. The processor 202 can complete operations corresponding to the instructions by executing computer readable instructions stored in the memory 206.

The memory 206 comprises an operating system 210, a network communication module 211 and an equipment management module 213. The equipment management module 213 can be implemented by computer readable instructions. The equipment management module 213 can comprise a model training module 212, a production adjustment module 216 and a feedback module 218. The computer readable instructions corresponding to the model training module 212, the production adjustment module 216 and the feedback module 218 can cause the processor 202 to implement the functions corresponding to the above model training module 112, production adjustment module 116 and feedback module 118 in each embodiment.

FIG. 3 is a flow diagram of an equipment management method according to an embodiment of the present application. The method 300 is implemented by the management equipment 110. The method 300 comprises the following steps.

S31: Acquire historical production data of a production equipment set.

The above production equipment set can comprise one or more pieces of production equipment.

The above historical production data can comprise a plurality of data sets. Each data set comprises values of a plurality of factors related to an operating condition of the production equipment set within a period of time. For example, different data sets can correspond to the values of the plurality of factors within different time periods, e.g., the values of the plurality of factors per day or per production cycle in the past period of time, etc. The plurality of factors mentioned here can comprise operating parameters, configuration data and the like of the production equipment. The operating parameters refer to various machine parameters obtained by measuring or sensing when the production equipment operates, e.g., current, voltage, motor operating speed, raw material input amount, product output amount, working duration and the like of the production equipment acquired by a sensor or an RFID reader, a code reader, etc. The configuration data refers to parameters related to the production plan, personnel and supporting facilities of a configuration, equipment failure, product qualification rate, scrap rate, etc.

S32: Train a plurality of component models in a composite model using the historical production data, wherein the output factor and input factor of each component model are factors with a preset parent-child relationship among the plurality of factors.

The preset parent-child relationship is used for describing one or more other factors (also referred to as child factors) that can affect the value of a factor (also referred to as a parent factor). The parent-child relationship can be determined according to actual conditions and experience. The preset parent-child relationship can be relatively broad, that is, for a parent factor, the parent-child relationship can comprise child factors that may affect or may not affect the parent factor. In the subsequent training process, the component models can identify these unnecessary child factors and remove them from the parent-child relationship. Different production equipment sets can involve different factor sets, so the training process can adopt different preset parent-child relationships.

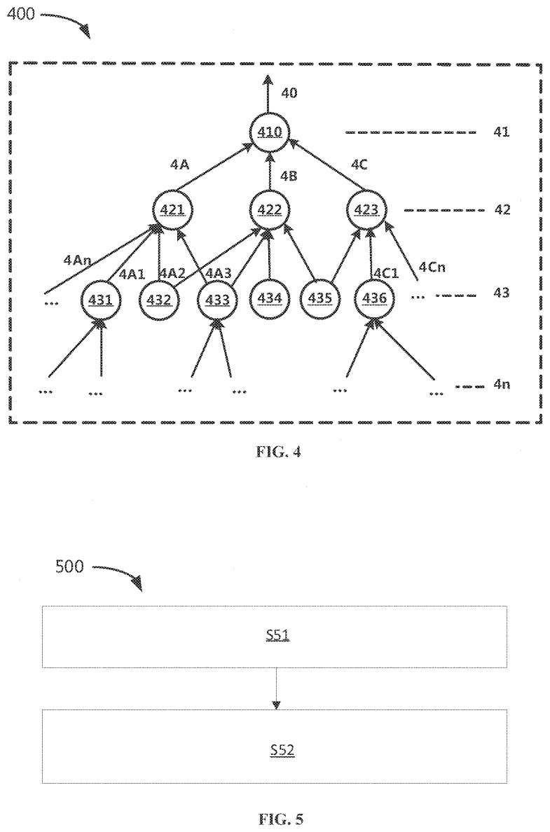

According to the preset parent-child relationship, a composite model composed of component models can be obtained. As shown in FIG. 4, the composite model 400 according to an embodiment comprises at least two layers, and each layer comprise one or more component models. In two adjacent layers, the output factor of a component model of a first layer of the two adjacent layers is the input factor of one or more component models of a second layer of the two adjacent layers. The output factor 40 of the composite model 400 is a production efficiency index of the production equipment set. For example, as shown in FIG. 4, the composite model 400 comprises n layers, i.e., layers 41, 42, 43 . . . 4n. The layer 41 comprises a component model 410 with input factors 4A, 4B, 4C; the layer 42 comprises component models 421, 422, 423; and the layer 43 comprises component models 431, 432, 433, 434, 435, 436, etc. In two adjacent layers, for example, in the layer 42 and the layer 43, the output factors 4A1, 4A2, 4A3 of the component models 431, 432, 433 of the layer 43 are the input factors of the component model 421 of the layer 42, the output factors 4A2, 4A3 of the component models 432, 433 are also the input factors of the component model 422 of the layer 42, the output factors 4Bn, 4C1 of the component models 435, 436 of the layer 43 are the input factors of the component model 423 of the layer 42, etc.

In the description, for the sake of convenience in description, the layer of the component model of which the output factor is the production efficiency index is referred to as a top layer; in two adjacent layers, the layer near the top model is referred to as an upper layer, and the layer far away from the top model is referred to as a lower layer; and the layer farthest away from the top layer among the layers is referred to as a bottom layer. The factors, except the output factors of the component models, among all the factors involved in the composite model are referred to as input factors of the composite model.

In some embodiments, the historical production data can comprise marked data, i.e., the data can comprise not only machine data and configuration data acquired from the production equipment set or the configuration equipment, but also the values of the marked output factors (hereinafter referred to as intermediate factors) of the component models. Using these marked data to train each component model, various supervised machine learning methods can be adopted. In some other embodiments, the historical production data can also comprise some unmarked data, i.e., the data can only comprise machine data and configuration data acquired from the production equipment set or the configuration equipment, but does not comprise the value of a parent factor. The component models can be trained using the marked data and the unmarked data, for example, various semi-supervised machine learning methods can be adopted.

S33: Acquire current production data of the production equipment set.

The current production data can comprise current values of a first factor. The first factor is one or more among the above plurality of factors.

The management equipment 110 can acquire the current production data of the production equipment set from the acquisition equipment 15 and the configuration equipment 17 or the database 114, for example, the current production plan, configuration parameters of the equipment, machine parameters of the current production equipment and the like, thus obtaining the current values of the first factor therefrom.

S34: Input the current values of the first factor to the composite model, and obtain an adjustment value of a second factor using the composite model. The second factor is one or more among the above plurality of factors.

The adjustment value of the second factor is value(s) of one or more factors that makes the predicted value of the production efficiency index satisfy a preset condition. That is, after the current values of the same factors in the first factors are replaced with the adjustment values of the second factors, the values of the obtained group of factors are input to the composite model, so that the predicted value of the production efficiency index output by the composite model satisfies a preset condition.

The preset condition is a preset adjustment target of the production efficiency index. For example, the preset condition can comprise, causing the predicted value of the production efficiency index to be greater than the current value of the production efficiency index (that is, the predicted value of the production efficiency index output by the composite model when the current values of the first factor are input to the composite model), or to fall into a range of an optimal value of the production efficiency index obtained according to the historical production data, or to reach an optimal value of the production efficiency index under the current condition (that is, the optimal value of the production efficiency index that can be achieved by adjusting the current values of part of the first factors only), etc.

The second factors and the first factors can be identical, or partially identical, or completely different two groups of factors. For example, when the input first factors are all the input factors required by the composite model (i.e., the factors except the output factors of the component models among the plurality of factors involved in the composite model), the second factor can be one or more factors that need to be adjusted; when the input first factors are part of the input factors required by the composite model, the one or more second factors can comprise factors different from the first factors among the input factors, etc.

S35: Provide the adjustment value of the second factor to the equipment related to the production equipment set.

In some embodiments, the adjustment value can be directly fed back to preset equipment. In some embodiments, an alarm signal can also be sent to the preset equipment when the adjustment value satisfies a certain preset condition; or the adjustment value is provided to the requesting equipment when a request of the equipment is received. As before, the equipment receiving the alarm and/or adjustment value can be one or more pieces of equipment, e.g., alarm equipment arranged at the production site, data display equipment arranged at the production site, equipment that is connected with a controller (e.g., PRC, etc.) of the production equipment and can adjust the operating parameters of the production equipment, equipment on which a certain enterprise management system runs, a terminal used by a production equipment manager, etc.

According to the embodiment of the present application, a multi-layer composite model is obtained by training with historical production data, so that the composite model can accurately describe the relationship between a large number of factors and a production efficiency index; and using this composite model, the factors that need to be adjusted can be identified from the current production data and a parameter adjustment proposal for optimizing the current production efficiency index can be given, thereby improving the productivity and performance of the production equipment.

FIG. 5 is a flow diagram of a method for training component models according to an embodiment of the present application. As shown in FIG. 5, the method 500 comprises the following steps.

S51: Train a first component model using historical production data to obtain a model parameter of a first input factor of the first component model that makes the output value of the composite model satisfy a preset condition.

S52: For a second component model of which the output factor is the first input factor, train the second component model using the historical production data and the model parameter of the first input factor to obtain a model parameter of a second input factor of the second component model.

The model parameter refers to a relationship between two or more factors in the input factors and output factors of the models, or a range of values of the various factors, and the set of these model parameters constitutes the model. The model parameter of the component model can comprise, but are not limited to, one or more of the followings: a relationship between the input factor and the output factor of the component model (e.g., a linear or nonlinear functional relationship fitted by an algorithm, etc.), a relationship among a plurality of input factors of the component model (e.g., a proportional relationship among a plurality of input factors, also referred to as weights of input factors, etc.), the range of values of the input factors, etc.

The upper model is trained first to obtain a model parameter of the upper model that makes the output value of the composite model satisfy a preset condition. When the lower model is trained, a model parameter of the input factor of the upper model is used as constraints of the output factor of the lower model, so that the composite model can accurately extract a relationship among the factors when the production efficiency index satisfies a preset condition (e.g., the value of the production efficiency index falls into a better range determined according to a preset method), to obtaining a parameter adjustment proposal (i.e., adjustment values of second factors) using the composite model later.

For example, the model parameter of the first input factor can comprise a first range of a value of the first input factor that makes the output value of the composite model satisfy a preset condition. In S52, for a second component model of which the output factor is the first input factor, the second component model can be trained using the historical production data to obtain the model parameter of the second input factor of the second component model that makes the value of the output factor of the second component model fall into the first range. For example, the model parameter of the second input factor of the second component model can comprise, but are not limited to, a second range into which the value of the second input factor of the second component model falls, or a relationship between the values of at least two second input factors of the second component model, etc.

In this way, the range of values of the input factor of the upper model is used as the range of values of the output factor of the lower model, and the model parameter of the lower model that makes the output value of the composite model satisfy a preset condition can be accurately extracted in the training of the lower model, so that a parameter adjustment proposal is obtained more accurately.

For another example, the model parameter of the first input factor can comprise a first relationship between the values of at least two first input factors of the first component model that makes the output value of the composite model satisfy a preset condition. In S52, for at least two second component models of which the output factors are the first input factors, the second component models can be jointly trained using historical production data to obtain the model parameter of the second input factor of the at least two second component models that makes the values of the output factors of the at least two second component models satisfy a first relationship. For example, the model parameters of the second input factors of the at least two second component models can comprise, but are not limited to, a range into which the values of the second input factors of the at least two second component models fall, or a relationship between the values of at least two second input factors of the at least two second component models, etc.

The at least two lower models are jointly trained using the first relationship between the first input factors of the upper model as the relationship between the output factors of the at least two lower models, and the model parameter of the lower model that makes the output value of the composite model satisfy a preset condition can be accurately extracted in the training of the lower model, so that a parameter adjustment proposal is obtained more accurately.

In some embodiments, when a plurality of component models are trained using historical production data, the third component model having M input factors can be trained using the values of M−1 input factors among the M input factors in the historical production data to obtain model parameters of the M−1 input factors in the third component model that make the output value of the composite model satisfy a preset condition, and a model parameter of a third input factor in the third component model is obtained using the model parameters of the M−1 input factors in the third component model. The third factor is a factor of the M input factors except the M−1 input factors. The calculation methods for the output factors of some component models are known, so that the component model can be trained using the output factor of the component model and the values of the M−1 input factors, and the model parameters of the third factor is calculated using the calculation method for the output factor and the model parameters of the M−1 input factors. For example, the OEE calculation method is: the product of availability (A), performance rate (P) and quality rate (Q). When the component model having the output factor OEE is trained, the component model can be trained using only the values of two (e.g., A and P) of A, P and Q and the value of OEE to obtain a relationship between the output factor and the input factors: optimal OEE=f1(A) or f2(P), and a relationship between A and P: k(A,w1)=k′(P,w2), wherein w1 and w2 are the ratios (also referred to as weights) of A and P. Then calculation formula for OEE is used to derive a relationship between Q and OEE: optimal OEE=f3(Q), and relationships between Q and A and between Q and P: m(Q,w3)=mr(P,w2), n(Q,w3)=n′(A,w1).

In this way, the model parameters of all the input factors of the component model can be obtained only using the data of the output factor and part of the input factors, which can significantly reduce the amount of calculation required for training the component model and improve the training efficiency.

In some embodiments, when a component model is trained, at least two fourth component models among the plurality of component models can be jointly trained based on a constraint that the value of the production efficiency index output by the composite model satisfies a preset condition to adjust model parameters of the at least two fourth component models. Joint training refers to regarding a plurality of component models as a whole and learning the relationship between the input factors and the output factors of the plurality of component models from historical production data. Since the joint training of the plurality of component models considers the mutual restriction relationship among the component models, the situation that the individual component model has an optimal output value but the output value of the composite model does not satisfy the preset condition can be avoided, and the parameter adjustment proposal obtained from the composite model is more accurate.

For example, the component models having at least one same input factor can be determined as fourth component models in order to solve the problem that the output values of the component models shift due to the incompletely consistent requirements of a plurality of component models having partially same input factors for the common input factors. The upper model of the fourth component models can be trained first to obtain a second relationship between at least two output factors of at least two fourth component models that makes the value of the production efficiency index output by the composite model satisfy a preset condition; and the model parameters of the at least two fourth component models are adjusted via joint training based on the constraint that the values of the at least two output factors of the at least two fourth component models satisfy the second relationship. For example, in the example of FIG. 4, since the component models 421 and 422 have the common input factors 4A2 and 4A3, the component models 421 and 422 can be jointly trained. Here, the value of the production efficiency index satisfying the preset condition is that the value of the production efficiency index is an optimal value obtained from the historical production data or the range of the optimal value. In some embodiments, the historical production data can be analyzed first to determine the optimal value of the production efficiency index or the range of the optimal value.

In this way, for a plurality of component models having common input factors, the model parameters that make the overall output of the plurality of component models to be optimal can be found by joint training, so that the constraints of the factors in the composite model are closer to a global optimal solution of these constraints.

For another example, in order to solve the problem that the optimal output of the lower model sometimes leads to degradation of the output of the upper model in the component models of the adjacent layers, at least one pair of component models among the plurality of component models can be determined as the fourth component models, wherein in the pair of component models, the output factor of one component model is the input factor of the other component model. The range of a value of an output factor of a fifth component model that makes the value of the production efficiency index output by the composite model satisfy a preset condition is obtained first, wherein the fifth component model is a component model closest to the output end (i.e., the top layer) of the composite model in the at least two fourth component models. Then, the model parameters of the at least two fourth component models are adjusted via joint training based on a constraint that the value of the output factor of the fifth component model falls into the range. For example, in the example of FIG. 4, the output factor of the component model 431 is the input factor of the component model 421, and thus the component models 421 and 431 can be jointly trained. In other examples, the component models 421, 431 and 432 or more component models can also be jointly trained.

By jointly training the component models of two adjacent layers, the relationship between the input factors of the lower model and the output factor of the upper models can be closer to a constraint relationship between these input factors and the output factor that makes the value of the production efficiency index output by the composite model satisfy a preset condition, so that the constraints of the factors in the composite model are closer to a global optimal solution of these constraints.

In various embodiments, in order to achieve a better training effect, separate training of a component model and joint training of a plurality of component models can use different sample data sets.

In some embodiments, the above trained composite model can be trained using unmarked historical production data and the existing semi-supervised learning algorithm or other machine learning algorithm. For example, second historical production data of the production equipment set can be acquired, and unsupervised training is performed on the composite model using the second historical production data. The second historical production data comprises unmarked data, i.e., only comprises values of input factors of the composite model, but does not comprise values of parent factors.

By training the composite model using the unmarked historical production data, the performance of the composite model can be further improved under the condition that less data is marked and the data is difficult to acquire.

In some embodiments, a new factor that affects the production efficiency index can be found in the production process, and the composite model can be trained using the production data comprising the value of the new factor, thereby incorporating the new factor into consideration of the composite model. For example, second current production data of the production equipment set can be acquired, wherein the second current production data comprises the values of the plurality of factors and a value of a fifth factor, and the fifth factor is a factor except the plurality of factors involved in the composite model, i.e., the above new factor. For a sixth component model in the plurality of component models, the fifth factor is used as the input factor of the sixth component model, and the sixth component model is trained using the value of the input factor of the sixth component model in the second current production data.

In this way, the new factor can be incorporated into consideration of the composite model by training the composite model using the production data comprising the value of the new factor, thereby further improving the performance of the composite model.

In some embodiments, the intermediate factors affected by the new factor may not be clear, and at least two component models among the plurality of component models can be trained as the sixth component models respectively to determine whether the component models are affected by the new factor. For example, the new factor can be used as an input factor of each component model in the composite model, and each component model is trained in turn, thereby exhausting various ways in which the new factor affects the production efficiency index and improving the performance of the composite model.

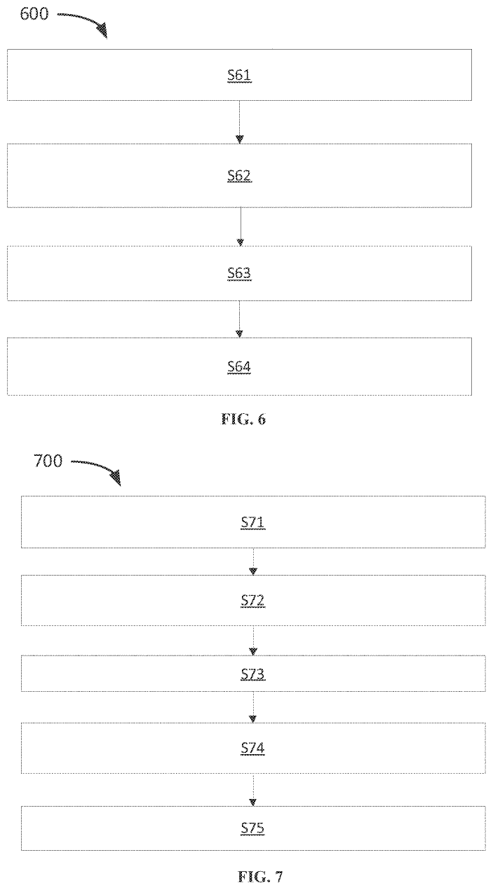

FIG. 6 is a flow diagram of a method for obtaining a parameter adjustment proposal using a composite model according to an embodiment of the present application. As shown in FIG. 6, the method 600 comprises the following steps.

S61: Input the current value(s) of one or more first factors to a plurality of component models in a composite model to obtain values of top input factors.

The top input factor is an input factor of a top component model in the composite model, and the top component model is a component model of which the output factor is a production efficiency index.

S62: Determine the predicted value, satisfying a preset condition, of the production efficiency index using the value of the top input factor and a model parameter of the top component model.

The predicted value of the production efficiency index refers to an optimal value of the production efficiency index that can be achieved by adjusting part of or all of the top input factors.

S63: Obtain an adjustment value of the input factor of each component model corresponding to the predicted value using model parameters of the component models.

S64: Determine the adjustment value(s) of one or more second factors from the adjustment values of the input factors of the component models.

In various embodiments, the values of the input factors of the top model are calculated using current production data. The optimal value of the production efficiency index is predicted using the top model Then the values of the input factors of each component model are obtained as adjustment values by deriving from the optimal value The adjustment values of each input factor corresponding to the optimal value of the predicted production efficiency index can be accurately calculated using the model parameters of each component model in the composite model, and the operating parameters of the production equipment set are adjusted using the output adjustment values, so that the production efficiency index of the production equipment set can be kept stable (satisfying a preset condition) and at a better level.

The predicted value of the production efficiency index obtained in step S62 can be different according to the adopted preset conditions.

For example, when the preset condition is the range (herein referred to as a first value range) of preferable values of the production efficiency index in the historical production data, the predicted value can be a value in the first value range of the production efficiency index obtained according to the historical production data and the preset condition. The first value range can be calculated according to a preset method. For example, a preset interval (e.g., first 10%) after the values of the production efficiency index extracted from the historical production data are sequenced by magnitude is used as the first value range; the range from a preset proportion of values (e.g., 85%) of the optimal value of the production efficiency index in the historical production data to the optimal value is used as the first value range, etc.

For another example, when the preset condition is the optimal value of the production efficiency index that can be achieved by adjusting the values of part of the top input factors only, the predicted value can be an optimal value among the values of the production efficiency index corresponding to the values of the top input factors. For example, when the production efficiency index values calculated from the current values of the top input factors A, P and Q through the relationships f1(A), f2(P) and f3(Q) between the input factors and the output factor of the top component model are respectively E1, E2 and E3, the optimal value among the E1, E2 and E3 can be used as the predicted value.

For another example, when the preset condition is the minimum adjustment making the production efficiency index fall into the first value range, the predicted value can be a value selected from the first value range and closest to the optimal value among the values of the production efficiency index corresponding to the values of the top input factors. For example, when the production efficiency index values calculated from the current values of the top input factors A, P and Q through the relationships f1(A), f2(P) and f3(Q) between the input factors and the output factor of the top component model are respectively E1, E2 and E3 and the first value range is E4 to E5, E6 in the value range from E4 to E5 can be used as a predicted value, wherein E6 is a value, in E4 to E5, closest to the optimal value among the E1, E2 and E3.

By setting different preset conditions, the management equipment can give different adjustment proposals corresponding to different demands of enterprises, so that the adjustment proposal mechanism is more flexible.

In some embodiments, the model parameter of each component model can comprise a relationship between the value of the input factor and the value of the output factor of each component model. In step S63, the adjustment value of each top input factor corresponding to the predicted value can be determined using the relationship between the value of the input factor and the value of the output factor of the top component model; for a component model of which the adjustment value of the output factor has been determined, the adjustment value of the input factor of the component model corresponding to the adjustment value of the output factor of the component model can be determined using the relationship between the value of the input factor and the value of the output factor of the component model. Using the characteristic that the output factor of a lower component model is used as the input factor of an upper component model in a multi-layer structure of a composite model, the predicted value of the production efficiency index obtained by the top component model is reversely deducted down layer by layer using the relationship between the input factor and the output factor learned by each component model to obtain adjustment value of the input factor of the component model of each layer, so that the obtained adjustment values of the input factors enable the production equipment set to achieve predicted preferable value of the production efficiency index according to the composite model.

In some embodiments, one or more of the input factors of each component model can be selected as second factors that need to be adjusted. For example, the factors except the one or more first factors among the input factors of the composite model can be determined as one or more second factors. Here, the input factors of the composite model are all factors involved in the component models except the output factors. For another example, one or more factors having adjustment values different from the current values in the one or more first factors can be determined as one or more second factors. An adjustment proposal is given by selecting part of the input factors, so that the output adjustment proposal is compact and intuitive, and the efficiency of equipment adjustment can be improved.

In various embodiments, the adjustment value of the second input factor can be provided to a variety of equipment related to the production equipment set in various forms.

For example, the adjustment value can be provided to fourth equipment connected to one or more pieces of production equipment for adjusting an operating condition of the one or more pieces of production equipment. The fourth equipment is connected to controllers of the one or more pieces of production equipment, and can send adjustment signals to the controllers of the production equipment, thereby changing the operating parameter values of the production equipment. In this way, a parameter adjustment proposal can be fed back to the production site in real time to directly adjust the operating condition of the production equipment, thereby improving the production efficiency.

For another example, the adjustment values can be provided to fifth equipment for displaying. The fifth equipment can be equipment arranged near the production equipment and having a display function, or equipment (e.g., a PC, a mobile phone) used by a manager of the production equipment, etc.

For another example, when it is determined that the adjustment values satisfy a preset condition, an alarm message is sent to sixth equipment. The preset condition refers to a condition for sending the alarm message. For example, the preset condition can be a threshold of difference between the adjustment values of the factors and the current values, a threshold of number of factors to be adjusted, etc. The sixth equipment can be equipment arranged at the production site, or equipment used by a manager of the production equipment, etc. The alarm message can be presented in warning light, prompt tone, prompt text or other manners. In some examples, after the alarm message is sent, the management equipment 110 can receive a data request from one piece of equipment and provide the stored adjustment values to the equipment that sends the data request.

The above is only an example. In other embodiments, the adjustment values can be provided to one or more pieces of equipment related to the production equipment set in any possible form as needed.

In some embodiments, when the management equipment 110 needs to create a composite model for a second production equipment set, it can be first determined whether the composite model created previously can be reused. For example, when certain equipment in the production equipment 16 is replaced or new equipment is added in FIG. 1A, or when a new factory is connected to the IoT platform 140 in FIG. 1B and the management equipment 110 needs to establish a composite model for a new factory, the existing composite model can be reused. The management equipment 110 can acquire historical production data of the second production equipment set, and generate a second composite model corresponding to the second production equipment set using the model parameters of the composite model of the other production equipment set when it is determined that the similarity between the historical production data of the second production equipment set and the historical production data of the other production equipment set satisfies a preset condition. The second production equipment set is a production equipment set for which a composite model needs to be created, and the other production equipment set is a production equipment set that has a composite model created. Since the probability that two production equipment sets have exactly the same data is very low, after the composite model of the second production equipment set is created using the model parameters of the existing composite model, the composite model can be verified or further trained and adjusted using the historical production data of the second production equipment set. Training based on the model parameters of the existing composite model can greatly improve the training efficiency, shorten the training time and save the processing resources of the management equipment 110.

FIG. 7 is a flow diagram of an equipment management method according to an embodiment of the present application. The method 700 is illustrated as the management equipment 110 constructs a composite model for predicting an OEE of a production equipment set and a parameter adjustment proposal is obtained using the composite model. As shown in FIG. 7, the method comprises the following steps.

S71: Perform first-layer modeling using an OEE in historical production data and data of three sub-factors (availability A, performance rate P and quality rate Q) of the OEE to obtain a top component model of a composite model.

Two of the three factors A, P and Q can be selected as input factors from the historical production data (e.g., from the IoT platform), the OEE is used as an output factor, and a component model is trained using a machine learning method (e.g., supervised learning, semi-supervised learning, reinforcement learning, etc.) to construct a top component model for optimizing the OEE (wherein the model parameter of the factor which is not used for training among the A, P and Q can be derived from the model parameters of the other two factors).

By inputting any factor to the top component model, this model can output a predicted optimal OEE.

S72: Construct respective component models for input factors of the trained component models according to a preset parent-child relationship.

Each of the three input factors of the top component model can be affected by different sub-factors. In the second layer of these input factors, in accordance with the training method similar to that in S71 above, the above three top input factors are respectively used as the output factors of the component models of this layer, and the input factors of these component models are determined according to a preset parent-child relationship. The component models of the second layer are trained using the values of these input factors and the values of the corresponding output factors in the historical production data. A component model of next layer is constructed for each input factor of the second layer respectively. By analogy, a multi-layer composite model consisting of model components of all layers is finally established.

In the above training process, an optimal input factor value can be derived from the constructed upper learning model, and then the optimal input factor value is added as a constraint to modeling of the component model using the input factor as an output factor on next layer to obtain an optimal component model of each layer.

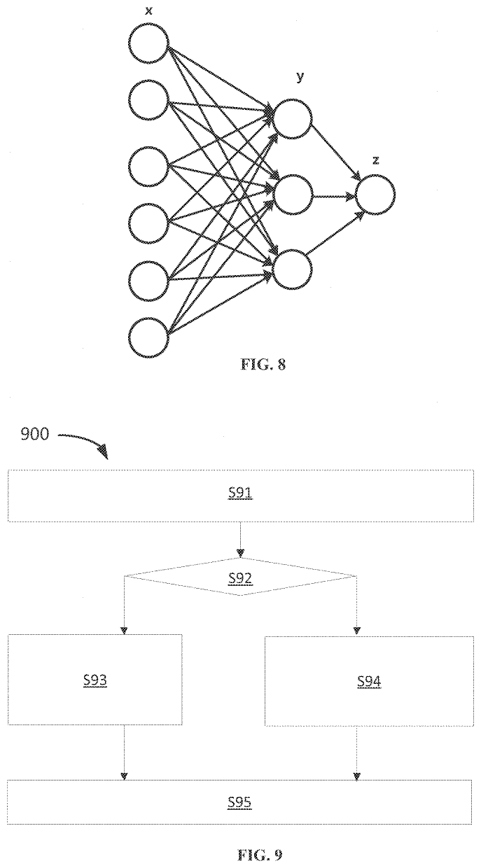

Modeling of each component model can adopt various machine learning methods. A back propagation (BP) neural network is used as an example to describe a supervised machine learning method for modeling of a component model. FIG. 8 is a schematic diagram of a BP neural network model. For simplicity in description, a two-layer neural network is taken as an example. A multi-layer neural network can be used in various embodiments.

Each node in the neural network is a neuron. The input layer x is used for acquiring data, and each individual node in the hidden layer y receives data from the input layer, and different outputs are calculated using different functions. The output layer z calculates the final result based on the outputs of the hidden layer.

Through learning, a function type can be selected according to the characteristics of a typical function type of the neural network, that is, a corresponding parameter calculation rule, and the output value of the function is set.

S73: Perform joint training in combination with a plurality of component models.

The optimal component model obtained by separately training each component model of each layer may not be an optimal solution under the entire end-to-end constraint. In order to establish a globally optimal composite model, the relevant component models are first combined and jointly trained within a larger range, thus improving each component model. For example, the component models of the same layer are jointly trained, and the component models in the adjacent upper and lower layers are jointly trained. Then, the scale of joint training is gradually expanded, that is, more component models are incorporated (e.g., more layers and more component models in each layer are incorporated, etc.) in joint training, and multiple joint trainings are performed to finally establish a globally optimal model from the bottom input factors to the top OEE calculation, thereby improving the overall accuracy of the composite model.

S74: Perform semi-supervised learning using the production data comprising a new factor, and adjust the component models and/or the composite model.

After the composite model is established, new factors affecting the OEE calculation may still be discovered in the actual production process. In order to use the data of these new factors, semi-supervised machine learning, e.g., self-training, joint training, etc., can be used for adding the new factors to the composite model.

FIG. 9 is a flow diagram of a training method for adding a new factor to a composite model according to an embodiment of the present application. As shown in FIG. 9, the method 900 comprises the following steps.

S91: Acquire production data comprising new factor data.

S92: Judge whether the production data is marked, if it is marked, execute S93; if not, execute S94.

S93: Acquire a component model of the new factor through the marked data, and train the component model.

S94: Traverse each component model by training each component model respectively using the new factor as the input factor of each component model.

S95: Jointly train a plurality of component models to adjust model parameters of the component models.

In this way, regardless of whether the production data comprising the new factor has been marked, the production data can be used for training the composite model, and the new factor is added to the composite model to improve the prediction accuracy of the composite model.

S75: Acquire an optimal OEE predicted value corresponding to the current production data using the composite model, and acquire adjustment values of input factors.

After a multi-layer composite model is established, the correlation between the input factors and the OEE is determined. The optimal OEE can be predicted according to the current production data, and the value of the optimal input factor is derived according to the optimal OEE.

In addition, with continuous input of new production data, the composite model can be continuously trained with the new data to improve the prediction accuracy.

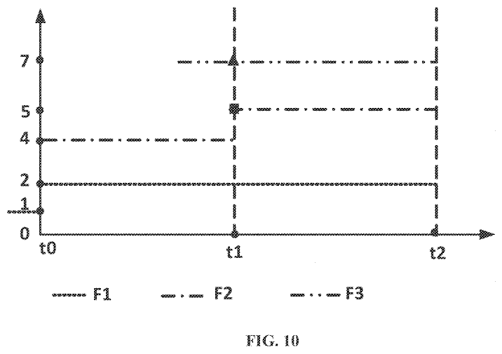

FIG. 10 is a schematic diagram of dynamic adjustment on production parameters according to an embodiment of the present application. As shown in FIG. 10, the abscissa axis indicates time and the longitudinal axis indicates values of factors, wherein the three kinds of lines represent three input factors F1, F2 and F3. Before the production start time t0, the management equipment 110 acquires a planned production parameter of current production, comprising the value 1 of the factor F1 and the value 4 of F2. Here only F1 and F2 are used as an example to simplify the description. In fact, a large number of other factors can be comprised. Before the production begins, the management equipment 110 can predict an OEE_0 corresponding to the planned production parameter using the established composite model, find that OEE_0 is lower than OEE_target which is an optimal value of the OEE learned during training, obtain a better OEE value, OEE_1, that can be achieved by adjusting part of the factors according to the current planned production parameter (comprising F1=1, F2=4), and feedback a parameter adjustment proposal corresponding to the OEE_1, for example, the adjustment value of F1 being 2, to the production enterprise. The production equipment set begins production from t0, and adjusts the value of F1 to 2 according to the proposal. After the production begins, the management equipment 110 continues to acquire the production data of the production equipment set for training the composite model. At the time t1, the management equipment 110 acquires the production data comprising a new factor F3 as an input factor of the composite model, and trains the composite model using the production data. OEE_2 at this time is predicted according to the current production parameters (comprising F1=2, F2=4, F3=7), and found to be less than OEE_target. It is found that the OEE_target can be achieved by adjusting part of the factors. A corresponding adjustment proposal, e.g., adjusting the value of F2 to 5, is obtained and fed back to the production enterprise. At the same time, the management equipment 110 continues to acquire the latest production data of the production equipment set for training the composite model. At the time t2, the management equipment 110 predicts OEE_3 at this time according to the current production parameters (comprising F1=2, F2=5, F3=7), finds that the OEE_3 equals to the OEE_target, and determines that the production equipment set is in a stable and efficient production status at this time, so that the parameters do not need to be adjusted and a message about no need to adjust is fed back to the production enterprise.

Using the solutions of the embodiments of the present application, a multi-layer composite model can be continuously trained before and during the production, and a parameter adjustment proposal is given in real time, so that unreasonable factors in the production can be adjusted in time, the production equipment is in a stable and efficient production status, the production efficiency is improved and the production resources are saved.

Through the description of the above embodiments, those skilled in the art can clearly understand that the above embodiments can be implemented by means of software plus a necessary universal hardware platform. Of course, the above embodiments can also be implemented through hardware. However, in many cases, the former is better. Based on such an understanding, the technical solution of the present application can be embodied completely or partially in the form of a software product, and the computer software product is stored in a storage medium, which comprises a plurality of instructions enabling computer equipment (which can be a personal computer, a server, or network equipment and the like) to execute the methods of the above embodiments.

The present application also provides a machine readable storage medium storing instructions for causing a machine to perform the methods as described above. Specifically, a system or a device equipped with a storage medium can be provided, the storage medium stores software program codes for implementing the functions of one of the above embodiments, and a computer (or CPU or MPU) of the system or the device can read and execute the program codes stored in the storage medium. In addition, part of or all of the actual operations can be completed by an operating system and the like run on a computer through the instructions based on program codes. The program codes read from the storage medium can also be written into a memory provided in an expansion board inserted into the computer or written into a memory provided in an expansion unit connected to the computer, and then part of or all of the actual operations are executed by a CPU and the like installed on the expansion board or the expansion unit through the instructions based on program codes, so that the functions of one of the above embodiments are implemented.

The storage medium embodiments for providing program codes comprise a soft disk, a hard disk, a magneto-optical disk, an optical disk (e.g., CD-ROM, CD-R, CD-RW, DVD-ROM, DVD-RAM, DVD-RW, DVD+RW), a magnetic tape, a non-volatile memory card and an ROM. Optionally, the program codes can be downloaded from a server computer via a communication network.

Described above are merely preferred embodiments of the present application, which are not used for limiting the present application. Any modification, equivalent replacement, improvement and the like made within the spirit and principle of the present application shall fall within the protection scope of the present application.

1. An equipment management method comprising:
acquiring historical production data of a production equipment set, the production equipment set including one or more pieces of production equipment, the historical production data including a plurality of data sets, and each data set of the plurality of data sets including values of a plurality of factors related to an operating condition of the production equipment set within a period of time;
training a plurality of component models in a composite model using the historical production data, wherein an output factor and an input factor of each component model, of the plurality of component models, are factors with a preset parent-child relationship among the plurality of factors, wherein the output factor of the composite model is a production efficiency index of the production equipment set, the composite model including at least two layers, and in two adjacent layers of the at least two layers, the output factor of a component model of a first layer of the two adjacent layers is the input factor of one or more component models of a second layer of the two adjacent layers;
acquiring current production data of the production equipment set, the current production data including a current value of a first factor, the first factor being one or more among the plurality of factors;
inputting the current value of the first factor to the composite model, and obtaining an adjustment value of a second factor using the composite model, the second factor being one or more factors among the plurality of factors, and the adjustment value of the second factor being one or more values of one or more factors that makes a predicted value of the production efficiency index satisfy a condition; and
providing the adjustment value of the second factor to equipment related to the production equipment set.

2. The method of claim 1, wherein training a plurality of component models using the historical production data comprises:
training a first component model using the historical production data to obtain a model parameter of a first input factor of the first component model that makes the output value of the composite model satisfy a condition; and
training, for a second component model of which the output factor is the first input factor, the second component model using the historical production data and the model parameter of the first input factors to obtain a model parameter of a second input factor of the second component model.

3. The method of claim 2, wherein the model parameter of the first input factor includes a first range of a value of the first input factor that makes the output value of the composite model satisfy a condition;
wherein the training the second component model using the historical production data and the model parameter of the first input factor to obtain a model parameter of a second input factor of the second component model comprises:
training, for a second component model of which the output factor is the first input factor, the second component model using the historical production data to obtain the model parameter of the second input factor of the second component model that makes a value of the output factor of the second component model fall into the first range.

4. The method of claim 2, wherein the model parameter of the first input factor includes a first relationship between the values of at least two first input factors of the first component model that makes the output value of the composite model satisfy a condition;
wherein the training the second component model using the historical production data and the model parameter of the first input factor to obtain a model parameter of a second input factor of the second component model includes:
jointly training, for at least two second component models of which the output factors are the at least two first input factors, the at least two second component models using the historical production data to obtain the model parameters of the second input factors of the at least two second component models that make the values of the output factors of the at least two second component models satisfy the first relationship.

5. The method of claim 1, wherein the training the plurality of component models using the historical production data comprises:
training, for a third component model having M input factors, the third component model using the values of M−1 input factors among the M input factors in the historical production data to obtain model parameters of the M−1 input factors in the third component model that make the output value of the composite model satisfy a preset condition; and
obtaining a model parameter of a third input factor in the third component model using the model parameters of the M−1 input factors in the third component model, the third factor being a factor of the M input factors, except the M−1 input factors.

6. The method according to claim 1, further comprising:
jointly training at least two fourth component models among the plurality of component models based on a constraint that the value of the production efficiency index output by the composite model satisfies a condition to adjust model parameters of the at least two fourth component models.

7. The method of claim 6, wherein the jointly training of the at least two fourth component models among the plurality of component models comprises:
determining component models having at least one same input factor as the fourth component models;
acquiring a second relationship between at least two output factors of the at least two fourth component models that makes the value of the production efficiency index output by the composite model satisfy a condition; and
adjusting the model parameters of the at least two fourth component models via the jointly training, based on a constraint that the values of at least two output factors of at least two fourth component models satisfy the second relationship.

8. The method of claim 6, wherein the jointly training of the at least two fourth component models among the plurality of component models comprises:
determining at least one pair of component models among the plurality of component models as the fourth component models, wherein in the pair of component models, the output factor of one component model is the input factor of another component model;
acquiring a range of a value of an output factor of a fifth component model that makes the value of the production efficiency index output by the composite model satisfy a condition, wherein the fifth component model is a component model relatively closest to an output end of the composite model in the at least two fourth component models; and
adjusting the model parameters of the at least two fourth component models, via the jointly training, based on a constraint that the value of the output factor of the fifth component model falls into the range.

9. The method of claim 1, further comprising:
acquiring second historical production data of the production equipment set, the second historical production data including unmarked data; and
training the composite model using the second historical production data.

10. The method of claim 1, further comprising:
acquiring second current production data of the production equipment set, the second current production data including the values of the plurality of factors and a value of a fifth factor, and the fifth factor being a factor other than the plurality of factors; and
training, for a sixth component model among the plurality of component models, the sixth component model using the fifth factor as an input factor of the sixth component model and using a value of the input factor of the sixth component model in the second current production data.

11. The method of claim 10, wherein the training of the sixth component model comprises:
respectively training at least two component models among the plurality of component models as the sixth component models.

12. The method of claim 1, wherein the obtaining of the adjustment value of a second factor using the composite model comprises:
inputting the current value of the first factor to a plurality of component models in the composite model to obtain a value of a top input factor, the top input factor being an input factor of a top component model in the composite model, and the top component model being a component model of which the output factor is the production efficiency index;
determining the predicted value, satisfying a condition, of the production efficiency index using the value of the top input factor and a model parameter of the top component model;
obtaining an adjustment value of the input factor of each component model corresponding to the predicted value using model parameters of the component models; and
determining the adjustment value of the second factor from the adjustment values of the input factors of the component models.

13. The method of claim 12, wherein the model parameter of each component model includes a relationship between the value of the input factor of each component model and a corresponding value of the output factor of the component module;
wherein the obtaining of the adjustment value of the input factor of each component model corresponding to the predicted value using model parameters of the component models comprises:
determining an adjustment value of each top input factor corresponding to the predicted value using the relationship between the value of the input factor and the value of the output factor of the top component model; and
determining, for a component model of which the adjustment value of the output factor has been determined, the adjustment value of the input factor of the component model corresponding to the adjustment value of the output factor of the component model using the relationship between the value of the input factor and the value of the output factor of the component model.

14. The method of claim 12, wherein in the determining of the predicted value, satisfying a condition, of the production efficiency index using the value of the top input factor and a model parameter of the top component model, the predicted value is:
a value in a first value range of the production efficiency index obtained according to the historical production data and the condition; or
an optimal value among the values of the production efficiency index corresponding to the values of the top input factors; or
a value selected from a first value range and relatively closest to an optimal value among the values of the production efficiency index corresponding to the values of the top input factors.

15. The method of claim 12, wherein the determining of the predicted value, satisfying the condition, of the production efficiency index using the values of the top input factors and the model parameters of the top component model comprises:
determining values of the production efficiency indexes corresponding to the values of the top input factors using a relationship between the value of the input factor and the value of the output factor of the top component model; and
selecting an optimal value from the values of the production efficiency indexes corresponding to the values of the top input factors as the predicted value.

16. The method of claim 12, wherein the determining of the adjustment values of the one or more second factors from the adjustment values of the input factors of the component models comprises at least one of:
determining factors, except the one or more first factors among the input factors of the composite model, as the one or more second factors, wherein the input factors of the composite model are factors except the output factors of the component models among the plurality of factors; and
determining one or more factors of which the adjustment values are different, from the current values among the one or more first factors as the one or more second factors.

17. The method of claim 1, wherein the providing of the adjustment values of the one or more second factors to equipment comprises at least one of:
providing the adjustment values to first equipment connected to the one or more pieces of production equipment, so that the first equipment adjusts the operating condition of the one or more pieces of production equipment according to the adjustment values;
providing the adjustment values to second equipment for displaying; and
sending an alarm message to third equipment upon determining that the adjustment values satisfy a condition.

18. The method of claim 1, further comprising:
acquiring historical production data of a second production equipment set; and
generating a second composite model corresponding to the second production equipment set, using a model parameter of the composite model, upon determining that the similarity between the historical production data of the second production equipment set and the historical production data of the production equipment set satisfies a condition.

19. An equipment management system comprising:
data storage equipment configured to:
store historical production data of a production equipment set the production equipment set including one or more pieces of production equipment, the historical production data including a plurality of data sets, and each data set of the plurality of data sets including values of a plurality of factors related to an operating condition of the production equipment set within a period of time; and
store current production data of the production equipment set, the current production data includes current values of a first factor, and the first factor being one or more factors among the plurality of factors;
an equipment management device configured to:
create a composite model according to a parent-child relationship among the plurality of factors, an output factor of the composite model being a production efficiency index of the production equipment set, the composite model including at least two layers of component models, in two adjacent layers, the output factor of a component model of a first layer of the two adjacent layers being the input factor of one or more component models of a second layer of the two adjacent layers, and the output factor and input factor of each component model being factors with the parent-child relationship among the plurality of factors;
train each component model in the composite model using the historical production data;
input the values of the first factors in the current production data to the composite model, and obtain an adjustment value of a second factor using the composite model, the second factor being one or more factors among the plurality of factors, and the adjustment value of the second factor being one or more values of one or more factors that makes a predicted value of the production efficiency index satisfy a condition; and
provide the adjustment value of the one or more second factors to equipment related to the production equipment set.

20. The system of claim 19, further comprising:
data acquisition equipment, configured to acquire data related to an operating condition of the one or more pieces of production equipment to generate values of the plurality of factors, the values of the plurality of factors being stored into the data storage equipment.

21. The system of claim 20, wherein the data acquisition equipment is configured to perform at least one of:
acquiring operating data of the production equipment through a first equipment connected to the production equipment or arranged near the production equipment;
receiving configuration data of the production equipment sent by second equipment; and
reading operating data and configuration data of the production equipment set from third equipment.

22. The system of claim 19, wherein,
the data storage equipment is configured to store historical production data of a plurality of production equipment sets; and
the equipment management device is configured to create a composite model corresponding to each production equipment set, separately for each production equipment set among the plurality of production equipment sets.

23. The system of claim 22, wherein,
the equipment management device is further configured to:
create a second composite model for a second production equipment set, among the plurality of production equipment sets,
search a third production equipment set from the plurality of production equipment sets, a similarity between historical production data of the third production equipment set and historical production data of the second production equipment set satisfying a condition, and
configure the second composite model using model parameters of a composite model corresponding to the third production equipment set.

24. The system of claim 19, wherein the equipment management device is further configured to perform at least one of:
providing the adjustment value to fourth equipment connected to the one or more pieces of production equipment for adjusting the operating condition of the one or more pieces of production equipment;
providing the adjustment value to fifth equipment for displaying; and
sending an alarm message to sixth equipment upon determining that the adjustment value satisfies a preset condition.

25. An equipment management device comprising:
a model training module, configured to
acquire historical production data of a production equipment set, the production equipment set including one or more pieces of production equipment, the historical production data including a plurality of data sets, and each data set, of the plurality of data sets including values of a plurality of factors related to an operating condition of the production equipment set within a period of time, and
train a plurality of component models in a composite model using the historical production data, an output factor and an input factor of each component model, of the plurality of component models being factors with a parent-child relationship among the plurality of factors, wherein an output factor of the composite model is a production efficiency index of the production equipment set, the composite model including at least two layers, and in two adjacent layers of the at least two layers, the output factor of a component model of a first layer of the two adjacent layers is the input factor of one or more component models of a second layer of the two adjacent layers;
a production adjustment module, configured to
acquire current production data of the production equipment set, the current production data including current values of a first factor, and the first factor being one factor or more among the plurality of factors; and to input the current values of the first factor to the composite model, and
obtain an adjustment value of a second factor using the composite model, the second factor being one or more factors among the plurality of factors, and the adjustment value of the second factor being one or more values of one or more factors that makes a predicted value of the production efficiency index satisfy a condition; and
a feedback module, configured to provide the adjustment value of the one or more second factors to terminal equipment related to the production equipment set.

26. An equipment management device, comprising:
a processor; and
a memory, to store
an application program executable by the processor to cause the processor to implement the method of claim 1.

27. A non-transitory computer readable storage medium, storing computer readable instructions, executable by a processor to implement the method of claim 1.

28. An equipment management device, comprising:
a processor; and
a memory, to store an application program executable by the processor to cause the processor to implement the method of claim 12.

29. A non-transitory computer readable storage medium, storing computer readable instructions, executable by a processor to implement the method of claim 12.
